(19) United States
(12) Patent Application Publication
(10) Pub. No.: US 2008/0253350 A1
(43) Pub. Date: Oct. 16, 2008

(54) Method and Device Using Randomized Hough Transform for Detecting Radio Systems with Periodic Emission Pattern

(75) Inventors: Kiran Challapali, New City, NY (US); Stefan Mangold, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,388

(22) PCT Filed: Jan. 28, 2005
(86) PCT No.: PCT/IB05/50385

§ 371 Date: Jul. 24, 2006

Related U.S. Application Data
(60) Provisional application No. 60/603,382, filed on Aug. 20, 2004.

(51) Int. Cl. H04J 3/00; G06K 9/36

(52) U.S. Cl. 370/345; 382/281

(57) ABSTRACT

The invention includes a method and device for identifying opportunities to transmit in a radio network. The method and device listen for a first, second, and third period of time to detect first, second, and third busy slots. A processor recognizes a sequence of the first, second, and third busy slots as a function of time, performs a Randomized Hough Transform on the sequence, generates a histogram based on the Randomized Hough Transform, identifies peaks in the histogram, determines whether the peaks correspond to a known radar, and identifies an opportunity to transmit.

This application claims the benefit of U.S. Provisional Application Ser. No. 60/541,207, filed Feb. 2, 2004, the teachings of which are incorporated herein by reference.

When radio networks encounter other devices, such as radars (e.g., primary emitters) or other radio networks (e.g., secondary emitters) that emit energy (and therefore use shared radio resources) in their vicinity, it is desirable to characterize the radio resource usage patterns of these other devices. Such a characterization of the usage patterns results in the identification of opportunities for the radio networks to transmit and/or receive signal. Wireless networks are generally allowed to operate only if they detect no radar. If a radio network detects an operational radar signal, the radio network must vacate that frequency bandwidth.

Hough Transforms have been employed for the detection of such other devices. As an example, Hough Transforms are used to detect radar pulses for use with any type of radio signals that create periodic patterns. The width repetition indicates what kind of radar is in use. The Hough Transform has been studied in image processing literature for detection of patterns such as lines, circles and ellipses in binary images. The effectiveness of Hough Transforms in detecting patterns in data with many overlaying patterns and random noise is proven. In the presence of outliers, the Hough Transform is more robust to noise than the commonly used least-squares estimation.

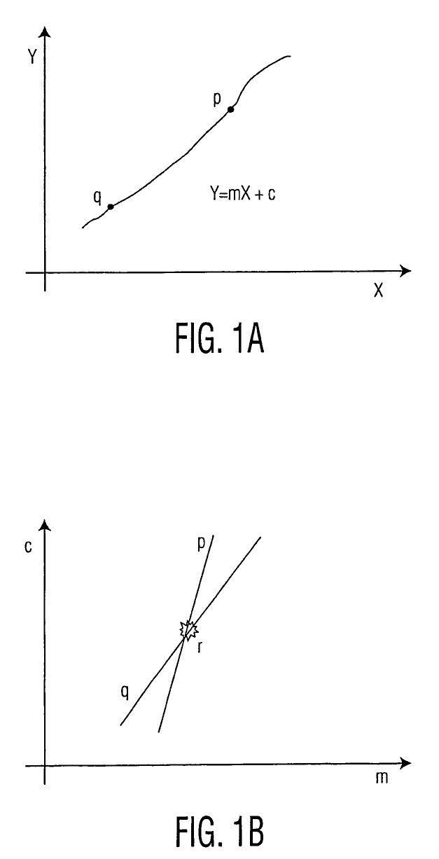

FIGS. 1A and 1B depict Hough Transforms for the detection of straight lines in image space (FIG. 1A) and parameter space (FIG. 1B). The image space is represented by (x, y), whereas, the parameter space is represented by (slope, intercept), that is (m, c). For each point in the image space (e.g. p and q) of FIG. 1A, a line is generated in the parameter space of FIG. 1B as shown. The parameter space can be seen as a two dimensional histogram. A peak (r) in the parameter space corresponds to a line in the image space. The Hough Transform is robust because in the image space, a collection of collinear points is enough to result in a peak in the parameter space. However, it has the drawback that the parameter space requires a large amount of computer memory in a detection device to detect straight lines (i.e., given a collection of one dimension measurements with two points yields a histogram of slope in parameter space).

A solution provided by the invention eases the memory requirements of the known method and device. The solution is to use a particular Hough Transform, known as Randomized Hough Transform (RHT), to detect the parameters of helixes wrapped around cylinders. The RHT as applied to straight-line detection, results in randomly picking pairs of points and computing and accumulating a parameter (for instance, slope). When enough confidence in the peak is achieved, the process stops, thus reducing both memory and processing time.

In one aspect, a method for identifying opportunities in a radio network includes several steps. On step is listening for a first period of time. Another step is detecting a first busy slot. Several additional steps include listening for a second period of time; detecting a second busy slot; listening for a third period of time; and detecting a third busy slot. Another step is recognizing a sequence of the first, second, and third busy slots as a function of time. Other steps include performing a Randomized Hough Transform on the sequence; generating a histogram based on the Randomized Hough Transform; identifying peaks in the histogram; determining whether the peaks correspond to a known radar; and identifying an opportunity to transmit.

In one embodiment, the method includes listening for at least a fourth period of time and detecting at least a fourth busy slot.

In another embodiment, the determining step determines whether the peaks correspond to a known radar in limited bandwidth.

In another aspect, a device for identifying opportunities in a radio network includes: a source; a processor for performing a computation which includes a means for performing an Randomized Hough Transform, a means for generating a histogram based on the Randomized Hough Transform, a means for identifying peaks in the histogram, and a means for identifying opportunities to transmit; a memory; and at least one listening device.

In one embodiment, the device includes a Medium Access Control, a Physical layer, and at least one transmitter.

In another embodiment, the listening device is an IEEE 802.11 slot mechanism.

The invention provides many advantages that are evident from the following description, drawings, and claims.

FIG. 1A depicts a Hough Transform used to detect straight lines in image space;

FIG. 1B depicts a Hough Transform used to detect straight lines in parameter space;

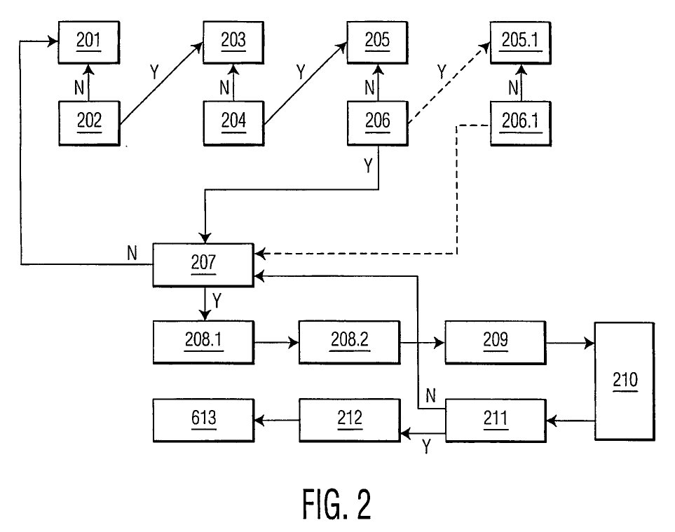

FIG. 2 depicts a method for detecting and characterizing the radio resource usage patterns of devices;

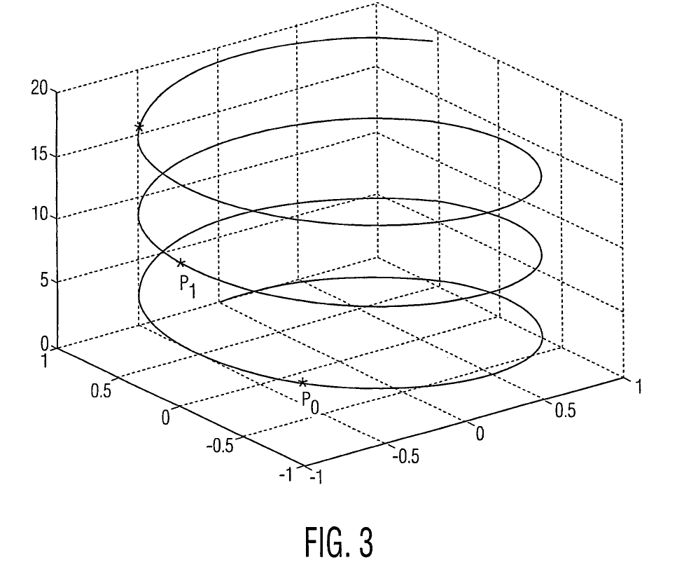

FIG. 3 depicts a graph of a helix given by RHT equation 1 above where ω=1;

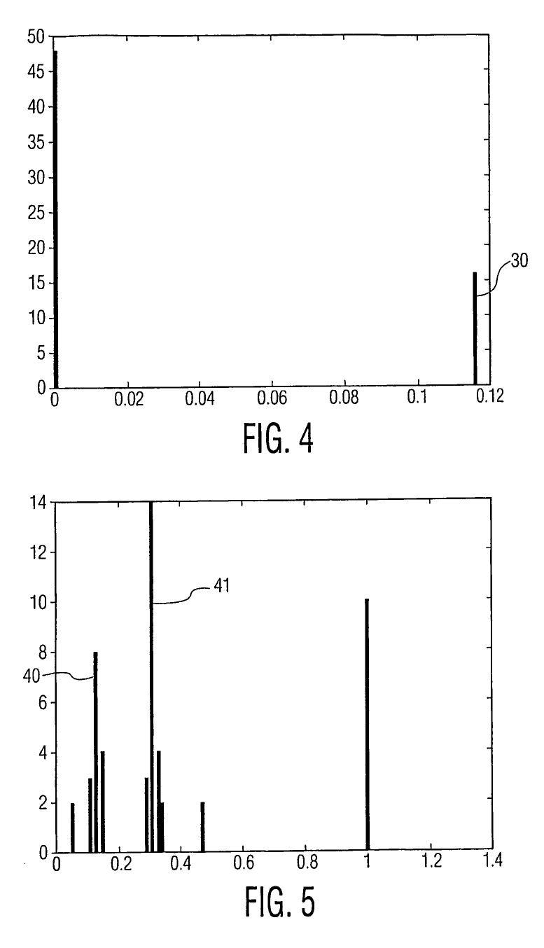

FIG. 4 depicts a histogram of ω for Lₚ₁;

FIG. 5 depicts a histogram of ω for Lₚ₂; and

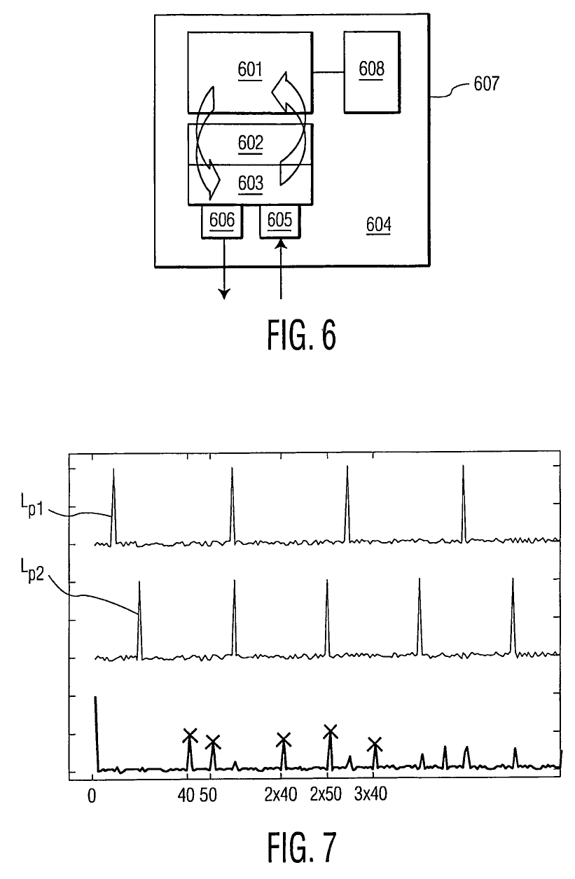

FIG. 6 depicts a device for detecting and characterizing the radio resource usage patterns of devices;

FIG. 7 depicts a graph of autocorrelation of measurement results in time.

FIG. 2 is a block diagram representing the various steps of a method of identifying opportunities to transmit and/or receive in a radio network. In step 201, a radio network device listens for a period of time to detect a first busy slot. Any type of listening device known in the art may accomplish this. The radio network device queries whether a first busy slot is detected in step 202. If not, the radio network device listens for an additional period of time for the first busy slot, returning to step 201. If the radio network device detects a first busy slot, it listens for a second period of time in step 203. The radio network device queries whether a second busy slot is detected in step 204. If not, it listens for an additional period of time for the second busy slot. If the radio network device detects a second busy slot, it listens for a third period of time in step 205. Only when the radio network device detects a third busy slot, confirmed by a query in step 206, will the process of generating a modified Hugh Transform begin. Additionally, in steps 205.1 and 206.1, the radio network device can listen for and query regarding a fourth busy slot, or any number of busy slot beyond steps 201-206.

Once the radio network device detects three busy slots in steps 201-206, it must recognize a sequence of the first, second, and third busy slots as a function of time in step 207. For example, the number of idle slots that separate the second busy slot from the first, as compared to the number of idle slots between the busy slots three and two should either be the same or their difference should be bounded by (i.e. less than) a small number. If it cannot recognize a sequence of the detected busy slots as a function of time, it begins a repetition of steps 201-206. If the radio network device recognizes a sequence of the first, second, and third busy slots as a function of time, software, an algorithm, and/or a processor performs a Randomized Hough Transform in steps 208.1-208.2 as described below.

The invention employs a 1-D to 3-D transformation (like a raster scan) and then applies the Hough Transform to detect straight lines, which correspond to pulse trains. Furthermore, a computation of the noise floor is incorporated. According to the method, in step 208.1, first, a transforming step transforms the 1-D signal to a 3-D helical signal. Next, in step 208.2, a conversion step applies a RHT to the 3-D helical signal.

The method can include generating a helix that may be represented by the following parametric equations:

X(t)=sin(ωt)

Y(t)=cos(ωt) (1)

Z(t)=t

This helix is cylindrical (as opposed to the more general elliptical) and has unit radius.

Based on the parameter ω a new helix can be generated that wraps around the cylinder more slowly as ω decreases. In FIG. 3, the points on the blue helix themselves form a helix, with an ω value less than one. Given two points on the helix P₀(x₀,y₀,z₀) and P₁(x₁,y₁,z₁), the parameter o can be given by the following equation:

$$ω = ( \frac{a tan ( \frac{{y}_{1}}{{x}_{1}} ) - a tan ( \frac{{y}_{0}}{{x}_{0}} )}{{z}_{1} - {z}_{0}} ) \qquad ( 2 )$$

If the two points P₀ and P₁ are inside one twirl of the helix, then ω works out to be 1. The length of the line segment given by one twirl of helix is

$$l = 2 * π * \sqrt{1 + {( \frac{1}{ω} )}^{2}} \qquad ( 3 )$$

In step 209 of FIG. 2, an algorithm or any other known histogram generating mechanism generates a histogram based on the Randomized Hough Transform performed in steps 609.1 and 609.2. As an example of the histogram generation in step 610, representing the location (time-of-arrival) of the radar pulse train of a single pulse that repeats at a rate of 50 pulses over a period of time with the vector Lₚ. For Lₚ₁=[9,59, 109,159,209,259,309,359], the ω histogram of FIG. 4 is obtained.

In step 210, the radio network identifies peaks in the histogram generated in step 209. Peak 30 of FIG. 4 represents the pulse repetition frequency in the signal sequence.

For the case depicted in FIG. 4, ω=0.116. However, FIG. 5 depicts the scenario where there are two pulse trains that are multiplexed at pulses that repeat at a rate of 40 and 50 pulses over a period of time and represented by Lₚ₂=[9, 20, 59, 60, 100, 109, 140, 159, 180, 209, 220, 259, 260, 300, 309, 340, 359]. Peaks 40 and 41 represent the pulse repetition frequency in the signal sequence corresponding to the rate of 40 and 50 in the sequence above. Note that ω=1 corresponds to points on the helix within one twirl. It can be ignored as an artifact of the model.

Once the peaks are identified in step 210, the radio network determines whether the peaks correspond to a known radar in step 211. This may occur, for example, by comparing the identified peaks to peak data stored in a memory. If the peaks do not correspond to a known radar, the radio network repeats steps 207-211. If the peaks do correspond to a known radar, then the radio network knows the period and use related to the radar and can identify opportunities to transmit and/or receive signal in step 212. The radio network transmits and/or receives in step 213 based on the opportunity identification of step 212.

The method may be associated with alternative ways of detection periodic interferences, which are for example based on the autocorrelation of measurement results in time. FIG. 7 shows the autocorrelation function of the two vectors Lₚ₁ and Lₚ₂. It can be seen that this method, similar to the Hough transform, detects the periods. The results of the different alternatives may be used to mutually assist the selection of decision thresholds. The combination of both methods can improve the detection probability.

FIG. 6 depicts a device for detecting and characterizing the radio resource usage patterns of devices. Device 607 may contain at least one antenna or other listening device 605, a transmitter 606, processor 601 and memory 608. Source 604 may be devices such as receiving systems, computers, notebook computers, PDAs, cells phones or other receiving devices or systems. Source 604 may provide the information over one or more network connections via, for example, a wireless wide area network, a wireless metropolitan area network, a wireless local area network, a terrestrial broadcast system (Radio, TV), a satellite network, a cell phone, or a wireless telephone network, wired networks, internal communication busses, internal connections, as well as portions or combinations of these and other types of networks.

As an example, if device 607 operates within an 802.11 WLAN, source 604 would contain Medium Access Control (MAC) layer 602 and a physical layer (PHY) 603. Processor 601 would direct listening device 605 to listen for a first period of time. When processor 601 detects a first busy slot, it directs listening device 605 to listen for a second period of time. When processor 602 detects a second busy slot, it directs listening device 605 to listen for a third period of time. Upon detecting a third busy slot, processor 601 recognizes a sequence of the first, second, and third busy slots as a function of time by comparing the busy slots to sequences stored in a memory 608. The connection between processor 601 and memory 608 may represent, for example, a bus, a communication network, one or more internal connections of a circuit, circuit card or other apparatus, as well as portions and combinations of these and other communication media.

Processor 601 then performs a Randomized Hough Transform on the sequence as previously explained using software, an algorithm, or any other means of computation. Processor 601 then generates a histogram based on the Randomized Hough Transform and identifies peaks in the histogram. Processor 601 then determines whether the peaks correspond to known radar by comparing the peaks to peak data stored in memory 608. Then processor 601 identifies an opportunity to transmit based on the known behavior of the now known radar Source 604 would then employ MAC 602 and PHY 603 to determine when to transmit using transmitter 606.

Processor 601 may be any means, such as an algorithm, general purpose, or special purpose computing system, or may be a hardware configuration, such as a laptop computer, desktop computer, a server, handheld computer, dedicated logic circuit, or integrated circuit. Processor 601 may also be Programmable Array Logic (PAL), Application Specific Integrated Circuit (ASIC), etc., which may be hardware programmed to include software instructions that provide a known output in response to known inputs. The elements illustrated herein may also be implemented as discrete hardware elements that are operable to perform the operations shown using coded logical operations or by executing hardware executable code.

The preceding expressions and examples are exemplary and are not intended to limit the scope of the claims that follow.

What is claimed is:

1. A method for identifying opportunities in a radio network comprising:
listening for a first period of time;
detecting a first busy slot;
listening for a second period of time;
detecting a second busy slot;
listening for a third period of time;
detecting a third busy slot;
recognizing a sequence of the first, second, and third busy slots as a function of time;
performing a Randomized Hough Transform on the sequence;
generating a histogram based on the Randomized Hough Transform;
identifying peaks in the histogram;
determining whether the peaks correspond to a known radar; and
identifying an opportunity to transmit.

2. The method of claim 1, wherein the method further comprises listening for at least a fourth period of time and detecting at least a fourth busy slot.

3. The method of claim 1, wherein the determining step determines whether the peaks correspond to a known radar in limited bandwidth.

4. A device (607) for identifying opportunities in a radio network comprising:
a) a source (604);
b) a processor (601) for performing a computation, said processor comprising:
a means for performing an Randomized Hough Transform, a means for generating a histogram based on the Randomized Hough Transform,
a means for identifying peaks in the histogram, and
a means for identifying opportunities to transmit
c) a memory (608); and
d) at least one listening device (605).

5. The device (607) of claim 4, wherein the device further comprises a Medium Access Control (602), a physical layer (603), and at least one transmitter (606).

6. The device of claim 4, wherein the listening device (607) is an IEEE 802.11 slot mechanism.
